(19) United States
(12) Patent Application Publication
(10) Pub. No.: US 2006/0119970 A1
(43) Pub. Date: Jun. 8, 2006

(54) Semiconductor device and magnetic recording system using the same

(75) Inventors: Yoshihiro Hayashi, Ome (JP); Fumihiko Arakawa, Tokorozawa (JP); Takeshi Kusunoki, Tachikawa (JP); Satoshi Ueno, Ome (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/291,814

(22) Filed: Dec. 2, 2005

(30) Foreign Application Priority Data
Dec. 2, 2004 (JP) 2004-349267

(51) Int. Cl. G11B 5/02; G11B 5/09

(52) U.S. Cl. 360/68; 360/46

(57) ABSTRACT

A write driver circuit capable of controlling the waveform of overshoot of a write current, more specifically, controlling a rise, amplitude, and duration of overshoot (OS) in the waveform of an output current independently of one another. The write driver circuit includes transistors for controlling the rise, amplitude, and duration of OS, an impedance matching unit between the write driver and the load, and a canceller of reflection waves from the head.

### INCORPORATION BY REFERENCE

The present application claims priority from Japanese application JP 2004-349267 filed on Dec. 2, 2004, the content of which is hereby incorporated by reference into this application.

### FIELD OF THE INVENTION

The present invention relates to a semiconductor device of a write drive circuit (write driver) of a magnetic recording system, and more specifically relates to a write driver operating in a good condition in a magnetic recording system of perpendicular magnetic recording type.

### BACKGROUND OF THE INVENTION

As a write driver for a magnetic recording system, there has been one type which changes the amplitude and the timing of an applied overshoot current corresponding to individual write current pulses so that the recording head can correctly record information on a recording medium (JP-A-2004-030730, for example).

### SUMMARY OF THE INVENTION

There have been requirements for higher recording density and speed increase in recording/reproducing frequency, which have been placed on magnetic recording systems, to record huge amounts of data on a recording medium and to reproduce data from a recording medium in a short period of time. In magnetic recording, a write current, generated by a writing drive circuit (write driver) corresponding to information to be recorded, is applied to the inductive head to generate a recording magnetic field to magnetize a magnetic medium in a specified direction to thereby record information. In this process, by using an overshoot current, the rise time of a write current is shortened and a speed increase in recording frequency can be realized.

Generally, in the magnetic recording system, an optimum write current waveform, which induces less error rate and less adjacent track interference, differs with an inductive head and magnetic media or a combination of them. For this reason, the write driver should preferably be able to minutely control the overshoot current to obtain an optimum waveform for each system.

FIG. 9 is a block diagram showing the structure of conventional write driver and a write signal transmission system in a magnetic recording system using the same write driver. Referring to FIG. 9, description will be made of waveform control of an overshoot (OS) current in a conventional circuit. The overshoot current waveform in the write driver represents the current waveforms generated by respective current generators. The upper portion of the waveform at the inductive head has been rounded by applied load, and shows a write current waveform at the inductive head. The write driver generates a control signal by a write data from a R/W channel IC and by settings stored in registers or ROMs. This control signal is used to control the duration and amplitude of the overshoot current. A control signal is sent to an overshoot generating circuit to generate an overshoot current. A write current is formed by a rectangular wave generator and an overshoot generator. An overshoot current is added to a rectangular current generated from write data and an output current is sent through a transmission line to an inductive head. Generally, a write current at the inductive head is slower in rising than the current at the output terminal of the write driver because of a transmission line and a head load. Therefore, even if a current waveform at the output terminal of the write driver is controlled so that its amplitude and duration are in desired states as shown in FIG. 9, the current becomes slow in rising affected by the load, and duration control is started before the time when the current reaches its peak level, with the result that the duration also changes in a manner following the pattern of the amplitude and it is impossible to control the duration independently.

Meanwhile, in the past, longitudinal magnetic recording was in widespread use, in which the medium magnetizing direction is in the plane of the medium, but to meet the requirement of high recording density in recent years, attention is being drawn to perpendicular magnetic recording, in which the medium magnetizing direction is a direction perpendicular to the plane of the medium. In longitudinal magnetic recording, because a write current is normally large, it was possible to curb the error rate and the adjacent track interference to such an extent that there is no problem from a practical standpoint without necessarily performing meticulous control of overshoot current waveform.

However, in perpendicular magnetic recording, because a write current is normally smaller than in longitudinal magnetic recording, it is surmised that effects of distortion or disturbance of the write current waveform on the recording error rate and the adjacent track interference of the magnetic recording system are more conspicuous than before. The inventors of the present invention looked to this problem as a theme to tackle on their own accord, and drew a conclusion that this problem could be solved uniquely by a means which will be described later.

JP-A-2004-030730 discloses that “incoming record data is processed, and an overshoot current is generated which matches the characteristic (impedance, for example) of the recording head at an operating frequency (calculated by analyzing record data and frequencies) of the recording head (Refer to paragraph 0031 of the patent document)”. However, the above patent document shows a configuration which selectively outputs an optimum combination of only amplitude and timing (phase) according to a record signal. Note, however, that as described above, in the conventional longitudinal magnetic recording, it is considered that by the revealed configuration of the above patent document, it was possible to secure a sufficient performance related to the recording error rate and the interference between tracks. On the other hand, in perpendicular magnetic recording of late, for the above reason, because much more precise control of a write current waveform is required, there is a problem that even if the configuration of the above patent document is applied as it stands, it is difficult to secure a sufficient performance.

A brief description will be made of the outline of a representative one of inventions disclosed in the present patent application. The write driver of the present invention controls the duration and the amplitude (height) of an overshoot current independently of each other to make it possible to generate an arbitrary overshoot waveform at the inductive head. The magnetic recording system is adapted such that though an optimum overshoot current waveform differs with the inductive head, magnetic media, and a transmission line, or a combination of them, it can generate or select an optimum overshoot waveform in accordance with those factors.

To be more specific, for use in a magnetic recording system for applying a write current corresponding to information to be recorded to the inductive head to generate a magnetic field to magnetize a magnetic medium in a specified direction by the magnetic field, a semiconductor device according to the present invention comprises a write driver circuit for having inputted therein a signal corresponding to the information to be recorded to generate a write current, and outputting the write current to the inductive head, wherein the write driver circuit is formed to be capable of controlling the amplitude and the duration of overshoot of the waveform of the write current to drive the inductive head independently of each other.

The semiconductor device of the present invention comprises a write driver circuit formed to be capable of controlling the amplitude and the duration of overshoot of the waveform of the write current to drive an inductive head to magnetize a magnetic medium in a specified direction by a magnetic field corresponding to information to be recorded, and generating a write current corresponding to the information to be recorded and applying the write current to the inductive head; and a control circuit for providing the write driver circuit with control information to control the waveform of the write current output from the write driver circuit.

A magnetic recording system of the present invention comprises an inductive head for generating a magnetic field based on a write current corresponding to information to be recorded to magnetize a medium in a specified direction; and a semiconductor device for generating the write current based on a signal corresponding to the information to be recorded and supplying the write current to the magnetic head, wherein the semiconductor device has the above-described characteristic features.

In a magnetic recording system, an optimum write current waveform for magnetic recording differs with an inductive head, a recording medium, and a transmission line connecting the write driver with the inductive head. Because there are a plurality of combinations of the above-mentioned parts when starting up a system, the write driver should preferably be able to generate a plurality of write current waveforms. Even after a combination of the above parts has been decided, an optimum current waveform will change with production variations of individual parts. For this reason, it is desirable not only that the write driver for magnetic recording can generate an optimum write current waveform compatible with several kinds of configuration of the magnetic recording system, but also that waveform control should be possible even to accommodate production variations in a combination of the above parts. Moreover, to increase the speed in recording frequency, the rise time in write current had better be short.

Since the write driver for magnetic recording according to the present invention is designed to control the amplitude and the duration of an overshoot current independently of each other, it is possible to perform meticulous control of the overshoot, and therefore it is possible to provide a magnetic recording system which records information on a medium in an optimum waveform of the write current.

Other objects, features and advantages of the invention will become apparent from the following description of the embodiments of the invention taken in conjunction with the accompanying drawings.

### BRIEF DESCRIPTION OF THE DRAWINGS

FIG. 1 shows a method of controlling a write current for magnetic recording in a magnetic recording system according to the present invention;

FIG. 2 shows a method of generating a write current for magnetic recording in the magnetic recording system according to the present invention;

FIG. 3 is a diagram showing an embodiment of a write driver for magnetic recording in the magnetic recording system according to the present invention;

FIG. 4 is an embodiment of control circuits for overshoot generator circuits and reflection cancellers in the write driver of FIG. 3;

FIG. 5 is a timing chart for explaining the operation of the overshoot generator circuits and the reflection cancellers of the write driver of FIG. 3;

FIG. 6 shows another embodiment of the write driver for magnetic recording in the magnetic recording system of the present invention;

FIG. 7 is yet another embodiment of the write driver for magnetic recording in the magnetic recording system of the present invention;

FIG. 8 is a still further embodiment of the write driver for magnetic recording in the magnetic recording system of the present invention; and

FIG. 9 is a method of generating a write current for magnetic recording in a conventional magnetic recording system.

### DETAILED DESCRIPTION OF THE EMBODIMENTS

The write driver converts received record data into a write current and transmits the current to the inductive head. The write current is formed by superposing an overshoot current on a rectangular wave signal. An optimum waveform of an overshoot current differs with an inductive head, a transmission line, recording media, and a recording frequency. Therefore, the write driver for magnetic recording of the present invention controls the duration and the amplitude of an overshoot current independently of each other to thereby optimize the waveform of the overshoot current.

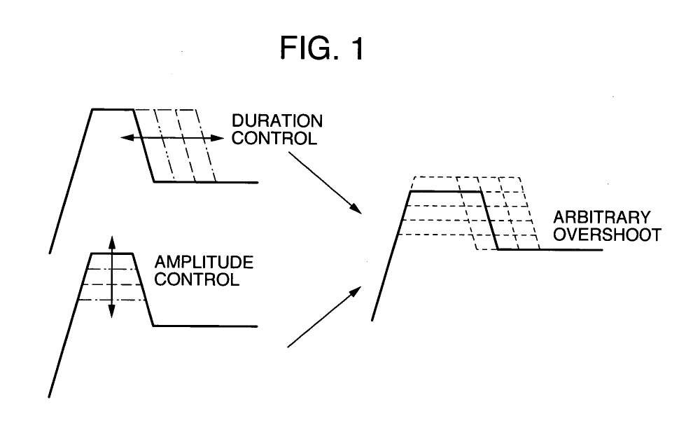

FIG. 1 is a diagram for explaining the principle of the present invention and shows in a simple form how an overshoot current waveform is generated at the inductive head of a magnetic recording system using a write driver circuit of the present invention. In a conventional circuit, as the amplitude and the duration of a current waveform at the inductive head change as a follow-up to the other, the waveform controllability has been low. In contrast, in the write driver circuit of the present invention, the duration and the amplitude are controlled independently of each other; therefore, it has become possible to generate an arbitrary waveform at the inductive head, thus assuring better waveform controllability than in the conventional circuit. Accordingly, it becomes possible to address various combinations of the inductive head, writing media, and so on with the same circuit.

Detailed description will be made of the best mode for carrying out the present invention by referring to embodiments shown in the accompanying drawings.

### Embodiment 1

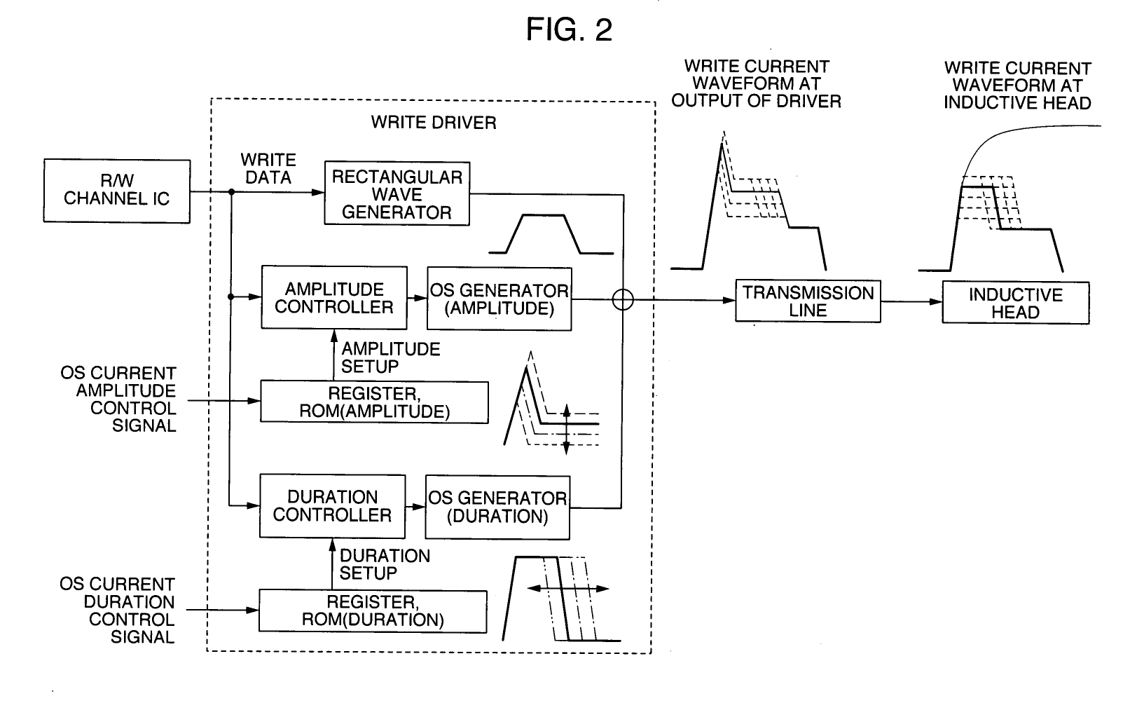

FIG. 2 is a block diagram showing a structure of a write driver of the present invention and an embodiment of a write signal transmission system of a magnetic recording system using the same write driver. Referring to FIG. 2, description will be made of waveform control of an overshoot (OS) current of a write driver circuit according to this embodiment.

The overshoot current waveform in the write driver in FIG. 2 represents the current waveforms generated by respective current generator circuits. The upper portion of the waveform at the inductive head is a result of a current waveform from the write driver being rounded by applied load, and the current waveform as illustrated occurs at the inductive head. A control signal is formed by applying settings, stored in a register or a ROM, to write data received from the R/W channel IC. By the control signal, the duration and the amplitude of an overshoot current is controlled, and a resultant signal is sent to the overshoot generator circuit, which generates an overshoot current.

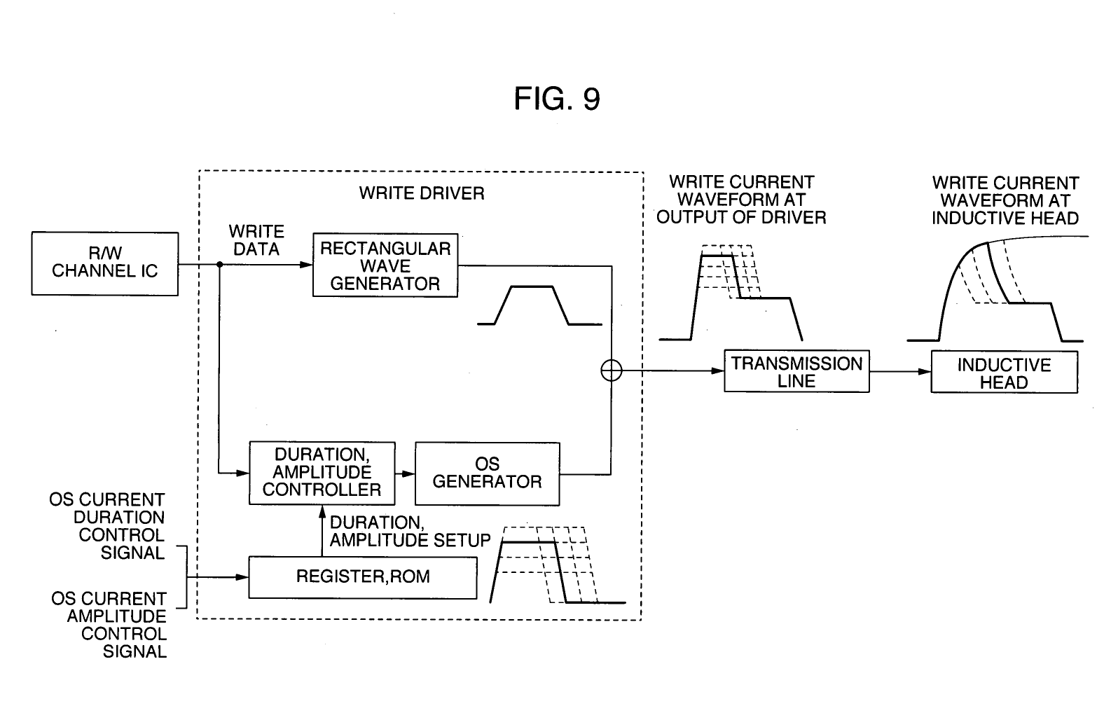

In the above-described conventional circuit in FIG. 9, an inductive current is formed by using a rectangular wave generator circuit and an overshoot generator circuit. Even if the amplitude and the duration have been controlled like the current waveform at the output terminal of the write driver as shown in FIG. 9 as described above, the rise of the waveform is delayed affected by the load, and duration control is started earlier than the time the current reaches a peak current, so that the duration also changes in a manner following the pattern of the amplitude and it was impossible to control the duration independently.

On the other hand, the circuit according to the present embodiment includes a rectangular wave generator circuit, a circuit for deciding the amplitude of overshoot, and a circuit for deciding the duration of overshoot. Signals for setting the duration and the amplitude of overshoot are processed as mutually independent control signals and sent to independent overshoot generator circuits. Overshoot currents generated by respective control circuits for the duration and the amplitude are added to a rectangular wave current, and a resulting current is sent through a transmission line to the inductive head.

When the overshoot current rises, preferably, a larger current than an actual current peak is output (for preemphasis). Due to this preemphasis, the head current rises at high speed and reaches a desired overshoot current before control is started. In this embodiment, preemphasis is superposed on an output current of the circuit for deciding the amplitude of overshoot. After this, the overshoot current is held by the circuit for deciding the amplitude of the overshoot current and the circuit for deciding the duration of the overshoot current. Finally, the current is made to fall by the circuit for deciding the duration of the overshoot current. The amplitude is controlled by controlling a time period for preemphasis and an output current of the circuit for deciding the amplitude. The duration is controlled by controlling timing of causing the overshoot current to fall by the circuit for deciding the duration.

As described above, the write driver for magnetic recording in this embodiment controls the amplitude and the duration of overshoot current independently of each other. Therefore, according to this embodiment, by implementing meticulous control of overshoot, it is possible to supply an optimum write current waveform for the magnetic recording system.

With the write driver in this embodiment, in addition to controlling the overshoot current by applying two parameters, amplitude and duration, independently of each other, the rise speed of a write current is increased. Therefore, by using preemphasis, the rise of write current, used to be decided by the time constant of the load and the amplitude of output current in a conventional circuit, is set at a substantially fixed speed, and it becomes possible to prevent a slowdown in the rise of write current from affecting control of the duration, and as a result, it is possible to generate an arbitrary waveform.

### Embodiment 2

Description will now be made of another embodiment of the write driver for magnetic recording in the present invention. According to a second embodiment, in a block diagram of FIG. 1, there is further provided a termination circuit which is used to make the impedance of the write driver match the impedance of a transmission line to which the magnetic head is connected. A concrete structure of the termination circuit will be described in detail in a subsequent embodiment.

According to the second embodiment, the termination circuit serves to reduce reflection waves produced by impedance mismatching between the write driver and the transmission line and also decrease current loss to the termination circuit. By this means, it is possible to suppress distortion of the current waveform due to reflection, and provide an optimum write current waveform.

### Embodiment 3

Description will be made of yet another embodiment of the write driver for magnetic recording in the present invention. In a third embodiment, in the block diagram of FIG. 2, a correction circuit is further provided for use in a case where reflection waves are produced by a mismatch between the impedance of the above-mentioned transmission line and the output impedance of the write driver for magnetic recording or by an impedance mismatch between the transmission line and the write head. A concrete example of the circuit for compensating reflection waves will be described in detail in an embodiment which appears later on.

According to the third embodiment, by using a circuit for compensating reflection waves, it is possible to cancel reflection waves caused by the above-mentioned impedance mismatching. Consequently, an optimum write current waveform can be provided.

### Embodiment 4

Description will be made of a further embodiment of the write driver for magnetic recording according to the present invention. In a fourth embodiment, the write driver circuit for magnetic recording of the present invention is configured in a symmetric structure. By this arrangement, flyback voltages are symmetric around the inductive head so that a common voltage does not change greatly.

According to the fourth embodiment, it becomes possible to suppress the effects of crosstalk, and it is also possible to easily set a common voltage at mid-point between the power supply voltages.

### Embodiment 5

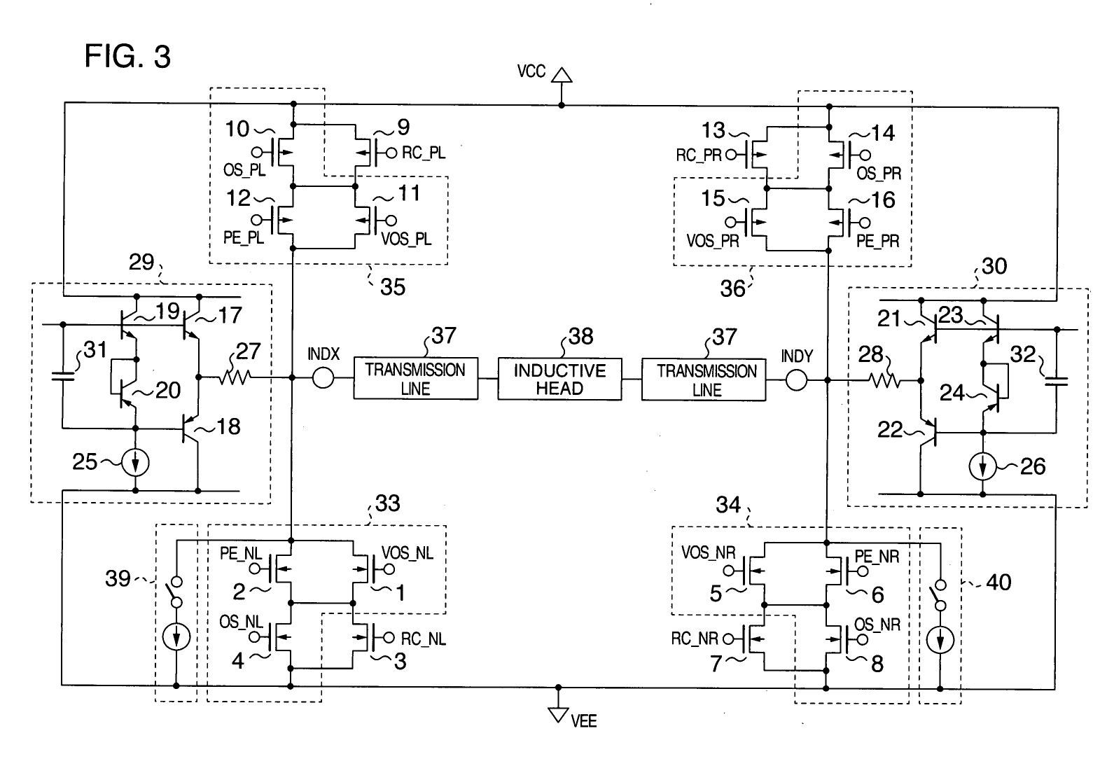

FIG. 3 is a circuit diagram showing an embodiment of a write driver for a magnetic disk storage system according to the present invention. For the write driver, H-bridge circuits are typically used so that currents may be driven in either direction through the inductive head.

The whole circuit in FIG. 3 includes circuits 33, 34, 35 and 36 for generating overshoots of the write current, circuits 3, 7, 9 and 13 for compensating reflection waves, operated in combination with the above-mentioned overshoot generator circuits, circuits 39, 40 for generating stable currents, and circuits 29, 30 for achieving impedance matching.

The overshoot generator circuits operate, 33 and 36 in one pair, and 34 and 35 in another pair, and generate overshoot currents with precipitous rises. Each overshoot generator circuit includes three transistors respectively capable of controlling the rise, the amplitude, and the duration of overshoot independently of each other. Heretofore, the rise time also changed in a manner following the pattern of the amplitude of overshoot. This is because the rise time is decided by the load driven by a preamplifier and an applied voltage. To shorten the rise time, it is necessary to apply a voltage higher than a voltage to obtain a required amplitude. For this reason, in this embodiment, a circuit for controlling the rise of overshoot is provided separately from the circuit for controlling the amplitude. By this circuit, it becomes possible to control the rise of an overshoot current and its amplitude independently of each other, and it is also possible to make constant the rise of overshoot regardless of the amplitude. Moreover, because the rise of overshoot can be made constant, the duration of overshoot can also be controlled meticulously. Further, the rise can be controlled easily.

In the overshoot generator circuits operating in a pair, the transistors which perform the same role operate at the same timing. In this respect, description will be made only of an overshoot generator circuit 33. Description will also be made of the operation of respective transistors when the overshoot generator circuits 33 and 36 are put into operation. Transistors 4 and 14 are used to control the duration of overshoot and therefore act as switches. Transistors 2 and 16 are used to control the duration of overshoot and operate as switches. Transistors 1 and 15 are adapted to control the height of overshoot and, according to an analog voltage applied to their gates, those transistors operate as current sources and control the overshoot current. When not in operation, the transistors 1 and 2 are off and the transistors 3 and 4 are on; therefore, the write driver des not supply a write current. When an overshoot occurs, the transistor 4 turns on in addition to the transistors 1 and 2 turned on. Because the transistors 2 and 4 operate as switches, it is possible that a large voltage is applied to INDX, and an overshoot current with a precipitous rise is supplied. After the overshoot current has risen, the transistor 2 is turned off. At this time, because the transistors 1 and 4 have been turned on, the overshoot current is controlled by the transistor 1 operating as the current source, and the amplitude can be kept constant. The duration of the overshoot current can be controlled at a timing when the transistor 4 is turned off. The transistor 1 turns on after the transistor 4 has turned off.

The operation of the overshoot generator circuits has been described. Since the overshoot generator circuits are arranged in a symmetric form, the transistors 1 and 5, 2 and 6, 3 and 7, and 4 and 8 on the VEE side and the transistors 9 and 13, 10 and 14, 11 and 15, and 12 and 16 on the VCC side have the same and corresponding roles, and this also holds true when the overshoot generator circuits 34 and 35 are put into operation.

As described above, since the overshoot generator circuits are arranged in a symmetric form, flyback voltages are symmetric around the inductive head. Therefore, it is possible to reduce changes in the common voltage of the inductive head when a write current is driven. Accordingly, it is possible to suppress crosstalk to the read head and its transmission line which are to be mounted generally side by side with the write head and its transmission line.

The transistor 3 is used to compensate reflection waves when reflection waves are produced by a mismatch of impedance between the write driver for magnetic recording and the transmission line 37. When a write current, driven by the write driver, reaches the inductive head 38 through the transmission lines 37, the current is reflected by an impedance mismatch. In addition, if an impedance matching cannot be achieved between the write driver and the transmission lines 37, the current reflected by the inductive head 38 is re-reflected. By this re-reflection, the write current waveform is distorted and a stable write current waveform cannot be generated depending on some speed of write data. For this reason, the distortion of the current waveform is corrected by applying a current in a direction reverse to the direction of the re-reflection at right timing when re-reflection occurs (referred to as a reflection canceller). The timing of a reflection wave being re-reflected at the output terminal of the write driver is determined by the time of the wave traveling outward and back on the transmission lines 37; therefore, settings differ with the transmission lines. In this embodiment, the reflection canceller is set so as to compensate an increase of the write current by re-reflection, but if the write current decreases by re-reflection, the reflection canceller may be operated to cancel the decrease.

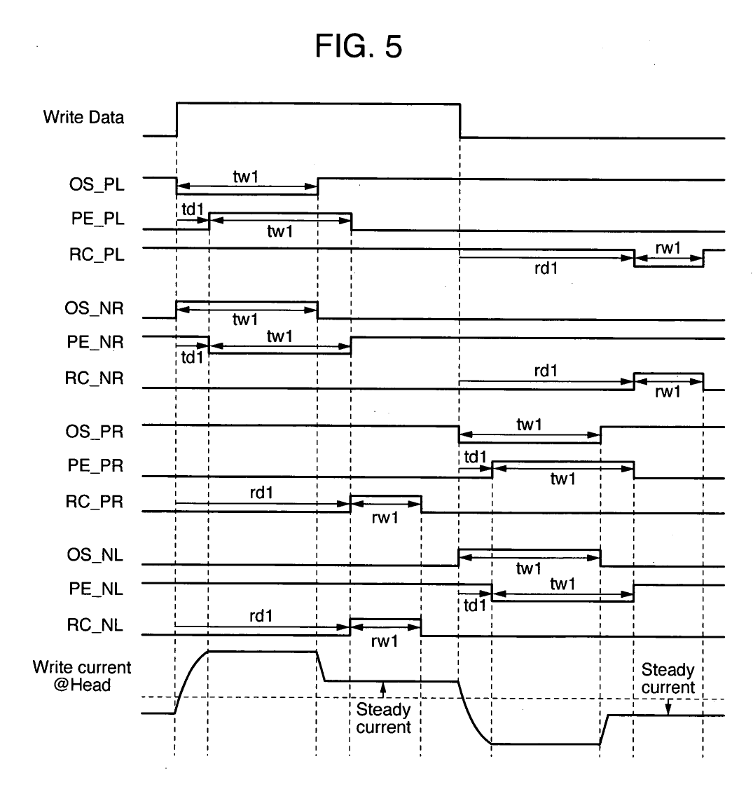

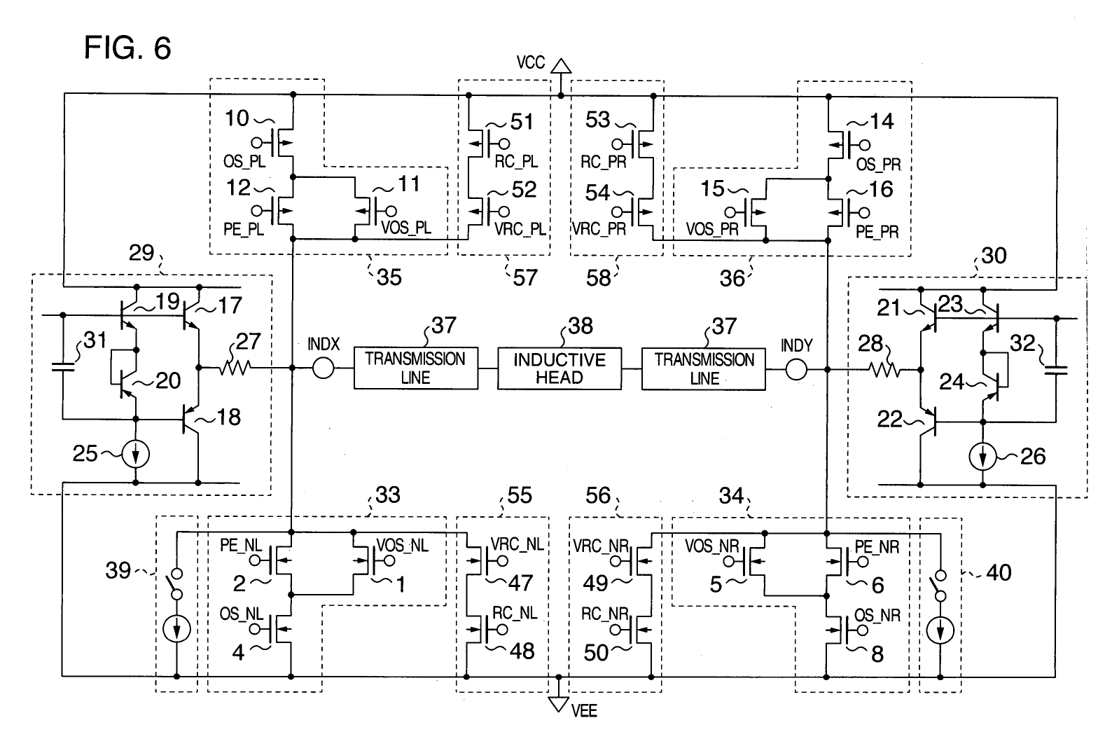

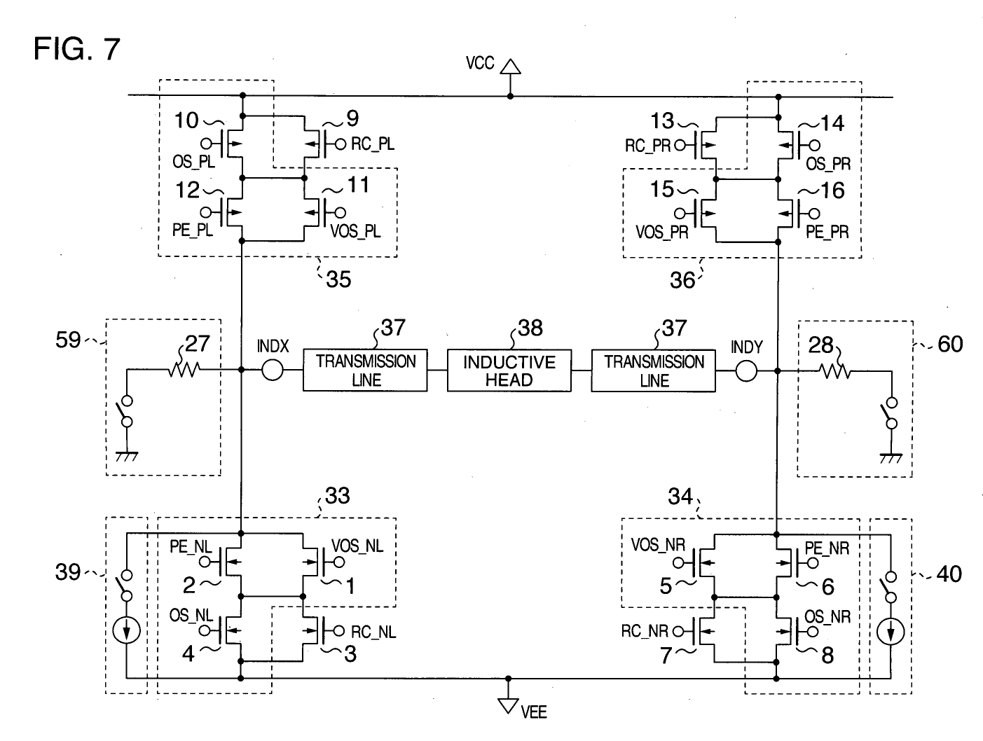

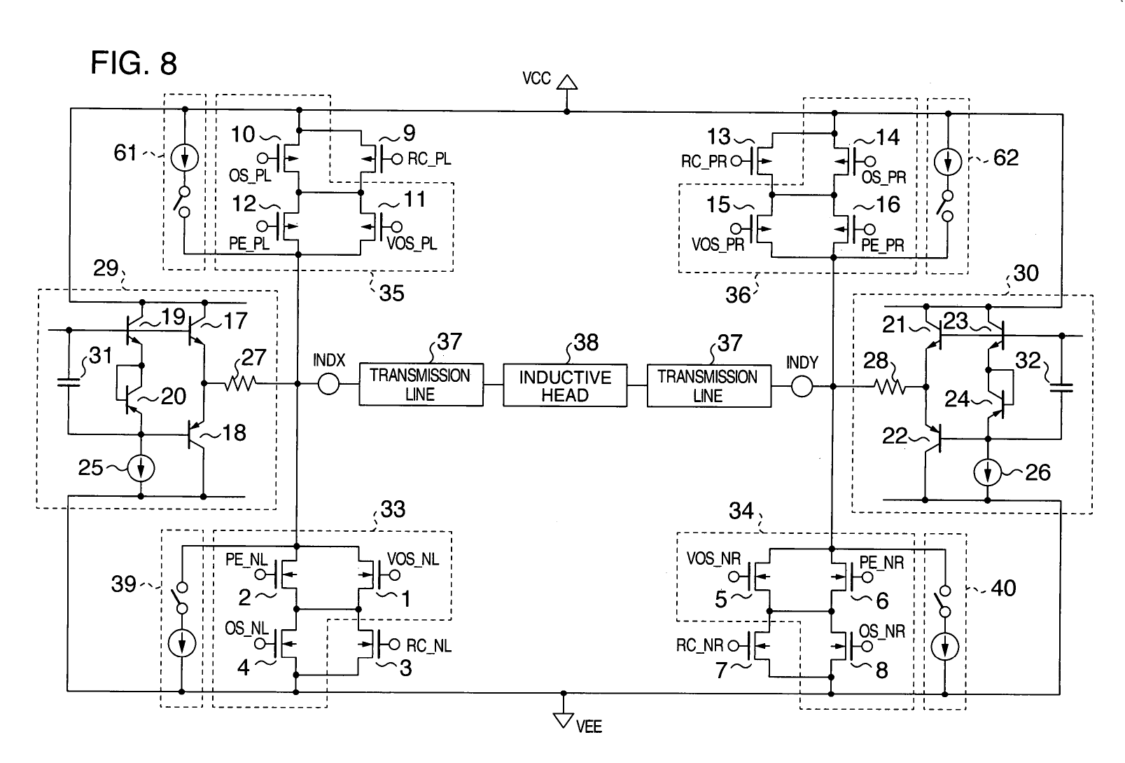

Control signal generators are composed of generators for overshoot duration 44, for rise time of overshoot 45 and for reflection canceller 46. Each generator has a level shifter to operate both VCC and VEE side transistors. Output signal names of control signal generators, for example OS PL and so on, correspond with those of in FIG. 5, FIG. 6, FIG. 7 and FIG. 8.

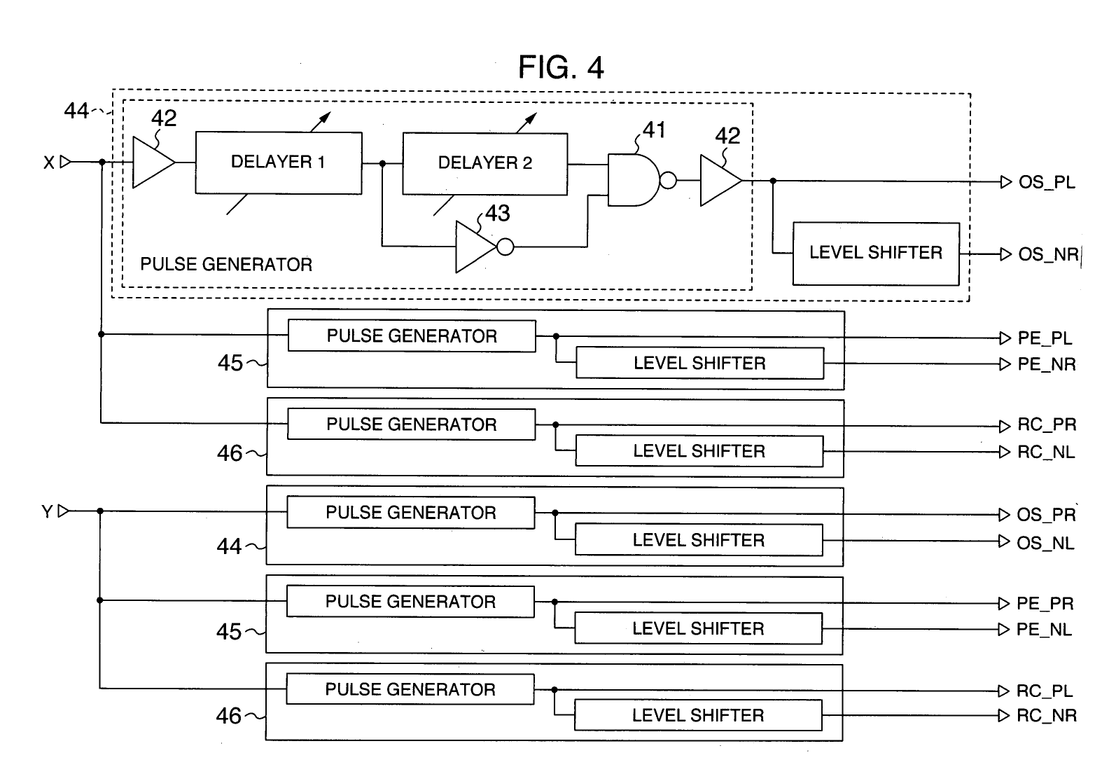

FIG. 4 shows an example each of an overshoot generator circuit and a control signal generator circuit of the reflection canceller in FIG. 3. FIG. 5 shows, by way of example, a timing chart of respective control signals. In FIG. 3, when the overshoot generator circuits 33 and 36 are operating, the transistors 7 and 9 operate as reflection cancellers. Control signals for the overshoot generator circuits and the reflection cancellers are formed from write data X and Y as incoming differential signals. Input write data is sent to a delayer 1. By adjusting a delay time of a delayer 1, it is possible to control timing between pulses. The data is then input to a delayer 2 and an inverter 43 to generate pulses. An inverted signal by the inverter 43 and a signal delayed by the delayer 2 are input to a NAND circuit 41. By adjusting a delay time difference between the above-mentioned two input signals, it is possible to control a pulse duration. Since the circuits are arranged in a symmetric form, delay times of the circuits for generating control signals of the same sort are adjusted to be the same at inputs X and Y. Incidentally, buffers or delay circuits, for example, may be inserted between the circuits or at the outputs. Input data need not necessarily be input from the inputs X and Y, but may be branched midway from another pulse generator circuit and input. A level signal to control overshoot is always input to the transistors for control of the amplitude of overshoot shown in FIG. 4.

Description will next be made of the termination circuit. Since the circuits are arranged symmetric around the inductive head, only one termination circuit 29 is described. The termination circuit 29 includes a portion where a PNP transistor 18 and an NPN transistor 17 operate complementarily, and also a circuit, formed by a series connection of an NPN transistor 19, a PNP transistor 20, and a current source 25, for setting the base voltage of the PNP transistor 18. A capacitor 31 is also connected to compensate variation in the base currents of the transistors 17 and 18. By controlling the base current of the NPN transistor 17 of the termination circuit 29 so that both ends of a transistor 27 are at the same potential, when the overshoot generator circuits are operating, it is possible to obtain an impedance match while reducing a current loss to the termination circuit. Concurrently, when a stable write current circuit 43 is in operation, the termination circuit 29 supplies a stable write current, and when a stable write current circuit 39 is in operation, the termination circuit 30 supplies a stable write current.

With regard to information for waveform control described above, it is possible to make such an arrangement that information about the amplitude and the duration (both or either one of them) of the overshoot current is input to the registers, integrated in a single semiconductor device (a semiconductor integrated circuit device, for example) along with the write driver circuit, and that the information input to the registers is decoded and decoded information is input to the control circuits. The control circuits, like the registers, may be integrated in the single semiconductor device together with the write driver circuit or they may be mounted on another semiconductor device separate from the write driver circuit. In the case where the control circuits are integrated with the write driver circuit, a resulting decrease in the number of parts enables downsizing of the system and lower power consumption. If the control circuits are mounted on a separate semiconductor device, since signals need not be delivered between the parts, favorable effects are that noise from the write-related circuits can be reduced, and that the deterioration of the reading characteristics can be lessened. If the control circuits are mounted separately from the write driver circuit, effects are that alterations in control can be facilitated, even if an alteration is made to the characteristics of the control circuit side or the write driver side, work is limited to one side, but not both sides and the write driver circuit may be reduced to a small scale.

Moreover, it is possible to make an arrangement that a correspondence table necessary for generating an output waveform is installed previously, a combination of waveform control signals is selected based on information input from registers, and signals are output to the control circuits. In this case, an effect is that the parameters visible from the side, where the write driver is operated, are only the amplitude and the duration of overshoot, which therefore can be controlled easily.

According to this embodiment, it becomes possible to independently control the rise and the amplitude of an overshoot current, and the rise of the overshoot can be kept constant regardless of the amplitude. Since the rise can be kept constant, the duration of overshoot can also be controlled meticulously. In addition, the rise can be controlled easily. Since the overshoot generator circuits are symmetric in structure, flyback voltages are symmetric around the inductive head, and therefore it is possible to reduce variation of a common voltage of the inductive head while a write current is driven. Thus, it is possible to decrease crosstalk to the read head and its transmission line, which are generally provided side by side with the write head and its transmission line.

### Embodiment 6

FIG. 6 is a circuit diagram of a still further embodiment of the write driver for a magnetic disk storage system according to the present invention. Like in FIG. 3, according to this embodiment, the write driver typically uses H-bridge circuits to enable currents to be driven in either direction through the induction head. However, the structure of the reflection canceller differs from that in FIG. 3. In FIG. 6, the reflection cancellers 57 to 60 are mounted in a system different from the overshoot generator circuits. The operation of the sixth embodiment will be described in the following. The overshoot generator circuits 55 to 58 operate in the same manner as in the fifth embodiment. The timing at which the reflection cancellers 53 to 56 operate is also the same as in the fifth embodiment, and their operation periods are controlled by periods when transistors 48, 50, 51, and 53 turn on. Note, however, that the reflection cancellers are mounted in a system separate from the system of the overshoot generator circuits, and the reflection cancellers are added with transistors 47, 49, 52, and 54. By controlling the gate voltages of the added transistors, the current quantities of the reflection cancellers can be adjusted independently of setting of overshoot currents.

According to the sixth embodiment, the reflection cancellers 57 to 60 are mounted in the different system, by controlling the gate voltages of the transistors 46, 48, 49, and 51; therefore, the current quantities of the reflection cancellers can be controlled. Thus, it becomes possible to compensate reflection waves with higher precision.

### Embodiment 7

FIG. 7 is a circuit diagram showing yet another embodiment of the write driver for a magnetic disk storage system of the present invention. As in FIG. 3, the write driver is typically formed by H-bridge circuits to make it possible to drive currents in both directions through the inductive head. Note, however, that the structure of the termination circuits is different from those in FIG. 3. In FIG. 7, termination circuits 57 and 58, each including a resistor and a switch connected in series, are used without using dynamic termination, such as by the termination circuits 29 and 30. Each switch is turned on only for periods of driving a stable write current, and the resistors are used for termination. The operation of this embodiment will be described in the following. The switches are turned off during operation periods of the overshoot generator circuit to separate the circuits on which a write current flows from the termination resistors. After the end of the operation of each overshoot circuit, the switches are turned on to connect to the termination resistors.

According to the seventh embodiment, by using simple termination with resistors, loss increases at the termination resistors, which however results in a simple circuitry, thus obviating the need of complicated control. When the overshoot generator circuit is operating, the impedance of the overshoot generator circuits becomes smaller than that of the termination resistors, which leads to an impedance mismatch. Therefore, while the overshoot generator circuits are in operation, the termination resistors have no significance of any kind, so that the termination circuits are cut off to reduce loss to the termination circuits. Or, the termination circuits may be connected only through the resistors to the ground without using the switches.

### Embodiment 8

FIG. 8 is a circuit diagram of a still further embodiment of the write driver for a magnetic disk storage system according to the present invention. As in FIG. 3, the write driver typically uses H-bridge circuits so that currents may be driven in either direction through the inductive head. However, the structure of the constant current generator circuits differs from those in FIG. 3. In this eighth embodiment, stable write currents are not supplied from the termination circuits 29 and 30, but stable write current generator circuits are provided also on the VCC side. The operation of this embodiment will be described as follows. Because not only the circuit is made symmetric around a straight line passing through the inductive head but also the circuit structure on the VCC side and the VEE side is made symmetric around a straight line passing across the inductive head, the variation in the common voltage of the inductive head is reduced to a smaller amount, and crosstalk can be decreased.

According to this embodiment, because stable write current generator circuits 59, 60 are provided also on the VCC side, the circuit is made symmetric around the inductive head, and effects of crosstalk can be reduced even smaller.

The fifth and eighth embodiments have been described referring to the circuit structure which uses MOS field effect transistors (MOSFETs) by way of a representative example. However, the present invention is not limited to this circuit structure, but may be embodied by using other types of transistor, such as bipolar transistors. When MOSFETs are used, a current does not flow to the gate; therefore, an effect is that the current flow can be controlled with high accuracy. On the other hand, when bipolar transistors are used, a large current can be driven, so that the circuit can be reduced in size.

It should be further understood by those skilled in the art that although the foregoing description has been made on embodiments of the invention, the invention is not limited thereto and various changes and modifications may be made without departing from the spirit of the invention and the scope of the appended claims.

1. For use in a magnetic recording device for applying a write current, corresponding to information to be recorded, to an inductive head to generate a magnetic field to magnetize a magnetic medium in a specified direction by a magnetic field, a semiconductor device comprising:
a write driver circuit for inputting therein a signal corresponding to the information to be recorded to generate a write current, and outputting the write current to said inductive head, wherein said write driver circuit is formed to be capable of controlling the amplitude and the duration of overshoot of a waveform of said write current to drive said inductive head independently of each other.

2. The semiconductor device according to claim 1, further comprising a control circuit for controlling said write driver.

3. The semiconductor device according to claim 1, wherein said write driver circuit includes a circuit for controlling a rise of said overshoot independeltly of said amplitude and said duration.

4. The semiconductor device according to claim 3, wherein said write driver circuit outputs a larger current than a current peak when said overshoot rises.

5. The semiconductor device according to claim 3, wherein said magnetic recording system is a magnetic recording system of perpendicular magnetic recording type for recording said information to be recorded on said medium by magnetizing said medium in a direction substantially perpendicular to a plane of said medium.

6. A semiconductor device comprises a write driver circuit formed to be capable controlling an amplitude and a duration of overshoot of a waveform of said write current to drive an inductive head to magnetize a magnetic medium in a specified direction by a magnetic field corresponding to information to be recorded, and generating a write current corresponding to said information to be recorded and applying said write current to said inductive head; and a control circuit for giving said write driver circuit control information to control a waveform of said write current output by said write driver circuit.

7. The semiconductor device according to claim 16, wherein said write driver circuit includes a circuit for controlling a rise of said overshoot independently of said amplitude and said duration.

8. The semiconductor device according to claim 7, wherein said write driver circuit performs preemphasis to output a larger current than a current peak when said overshoot rises.

9. The semiconductor device according to claim 8, wherein said write current is formed by superposing an output current of said preemphasis on an output current of a circuit for deciding said amplitude of overshoot, holding said overshoot by said circuit for deciding said amplitude of said overshoot and a circuit for deciding said duration of said overshoot, and causing the overshoot current to fall by said circuit for deciding said duration.

10. The semiconductor device according to claim 8, wherein said amplitude of said overshoot is controlled by controlling a period of applying said preemphasis and an output current of said circuit for deciding and said amplitude of said overshoot.

11. The semiconductor device according to claim 8, wherein the duration of said overshoot is controlled by controlling timing of causing said overshoot current to fall by said circuit for deciding the duration of said overshoot.

12. The semiconductor device according to claim 6, wherein said write driver circuit includes a circuit for compensating reflection waves generated by reflection of said write current by said inductive head.

13. The semiconductor device according to claim 6, wherein said write driver circuit includes a termination circuit capable of dynamic impedance matching.

14. The semiconductor device according to claim 6, wherein said write driver circuit is formed to be axisymmetric around a straight line passing through said inductive head.

15. The semiconductor device according to claim 6, wherein the current waveform of said overshoot has a first region and a second region demarcated at a time when a waveform changes from a peak point where the current is largest to an almost flat waveform, said first region on a side including said peak point and said second region on the other side including said almost flat waveform, wherein said first and said second regions are controlled independently of each other, namely, by controlling said first region, the amplitude of said overshoot is controlled, and by controlling said second region, a current accumulated value of said overshoot is controlled.

16. The semiconductor device according to claim 6, wherein the amplitude of said overshoot is controlled in combination with input pulses of said overshoot generator circuit.

17. The semiconductor device according to claim 16, wherein the amplitude of said overshoot is controlled by an input voltage to said overshoot generator circuit.

18. The semiconductor device according to claim 6, further comprising registers for holding information at least one of the amplitude and the duration of said overshoot.

19. The semiconductor device according to claim 18, wherein said overshoot is controlled by inputting information about at least the amplitude and the duration of said overshoot in said registers, decoding input information, and outputting decoded information to said control circuit.

20. The semiconductor device according to claim 18, further comprising a correspondence table storing correspondence relation between information about at least one of the amplitude and the duration of said overshoot, and waveform control signals, wherein said overshoot is controlled by selecting a combination of said waveform control signals from said correspondence table on the basis of input information from said registers, and outputting a selected combination to said control circuit.

21. The semiconductor device according to claim 6, wherein said inductive head is an inductive head of perpendicular magnetic recording type for recording said information to be recorded on said medium by magnetizing said medium in a direction substantially perpendicular to a plane of said medium.

22-37. (canceled)
